(19) United States
(12) Patent Application Publication
(10) Pub. No.: US 2017/0367424 A1
(43) Pub. Date: Dec. 28, 2017

(54) Self-Decoratable Sporting Helmet

(71) Applicant: Michael Timothy Rowntree, Missouri City, TX (US)

(72) Inventor: Michael Timothy Rowntree, Missouri City, TX (US)

(21) Appl. No.: 15/193,023

(22) Filed: Jun. 25, 2016

(51) Int. Cl. A42B 3/04; A42B 3/12; A63B 71/10; B08B 1/00

(52) U.S. Cl. CPC A42B 3/0406; B08B 1/006; A42B 3/125; A63B 71/10

(57) ABSTRACT

One embodiment of a helmet 10, upon which markers 14 are used to add decorations to the plastic outer shell 12. The ink from the markers 14 dries quickly, and thereafter becomes waterproof and unable to be removed without the use of chemicals or without damaging the plastic outer shell 12 of the helmet 10. The decorations thus applied are able to withstand the expected rigors of sporting activity without being erased. In addition, a solvent based cleaning solution 18 and a means for applying the solvent based cleaning solution 18 to the plastic outer shell 12 of the helmet 10 is used to erase any mistakes in the decorations, or to erase them entirely, thereby allowing the user to re-decorate the helmet 10 whenever they so desire.

### BACKGROUND

### Prior Art

The following is a tabulation of some prior art that presently appears relevant:

U.S. Patents

| | Publication | | |
|---|---|---|---|
| Patent Number | Date | Patentee | Title |
| US4307471 A | Dec. 29, 1981 | Peter J. Lovell | Protective helmet |
| US20150135415 | May 21, 2015 | Robert | Helmet with a |
| A1 | | Oppenheim | Writing Surface, |
| | | | Markers, and |
| | | | Stencil Kit |
| US5734994 A | Apr. 7, 1998 | David C. Rogers | Ventilated safety |
| | | | helmet with |
| | | | progressively |
| | | | crushable liner |
| US5337421 A | Aug. 16, 1994 | Yen-Ming Jeng | Air ventilation |
| | | | helmet |
| US6848122 B1 | Jan. 12, 2004 | Joe Meeds | Decorative |
| | | | removable helmet |
| | | | cover for ski, |
| | | | snowboard, |
| | | | skateboard and |
| | | | various types |
| | | | of helmets |

Sporting helmets were created for those participating in activities such as biking and skateboarding in order to protect their heads in the foreseeable occurrence of crashes. However, despite their safety benefits, many people choose not to use sporting helmets due to a perception that they are not stylish, which makes their user feel self-conscious. A few solutions to this problem have been ventured, but significant problems still remain.

Helmet makers have tried to overcome the problem of making their helmets appear stylish to users by decorating helmets as part of their production process. Manufacturers will commonly adorn their helmets in colors and designs which they believe will appeal to users, which in turn will make the user willing to wear the helmet during sporting activities. This solution, however, leaves much to be desired. First, the designs placed on the helmet by manufacturers are chosen by the manufacturer. Thus, the helmet user is cut out of the design process entirely. Second, the designs placed on the helmet by the manufacturer are permanent, and therefore the user cannot change the appearance of the helmet should their tastes change over time.

Artistically inclined helmet users can modify pre-decorated helmets made by manufacturers. However, this solution presents two drawbacks. The chemicals used in many paints and inks are incompatible with the plastics and foams used to construct sporting helmets, and can damage the helmets and reduce their effectiveness in crashes, rendering them unsafe. Further, many art products either do not adhere with any permanence to the plastic shells of helmets, or otherwise become completely irremovable. Both potentialities present problems, as either the user's designs can be lost through predictable use and contact that occurs in the sporting activities for which helmets are used, or otherwise the permanence of the bond between the art medium and the helmet would render mistakes permanent and designs unalterable.

Oppenheim discloses a system of helmets with a dry-erase board like surface, together with dry-erase markers and stencils. This system allows users to decorate their own helmets; yet, by design, the decorations are impermanent. Dry-erase marker ink was created with the explicit intent of not forming a lasting bond with the surface that is marked, so that any markings can be easily wiped or washed away. This impermanence poses a problem in the case of decorating a helmet, as helmets are intended to be handled, put on and taken off, and can expect to be touched and impacted, or to come into contact with sweat or water in the normal course of sporting activities. Thus, any decoration put on Oppenheim's helmet can be expected to be rubbed off or disturbed during common usage. This shortcoming dissuades the user from investing time and effort in making elaborate decorations on their helmet, as they can anticipate their work will be destroyed during use. Such impermanence limits the potential of designs users would be willing to put on Oppenheim's helmet. Furthermore, the ease with which Oppenheim's ink is removed, and the active nature in which sporting helmets are used, presents a high likelihood that in common use of the helmet, some of the ink will be inadvertently removed and end up on the user's hands, clothes, furniture, or other unintended surfaces, thus causing unwanted messes.

Meeds discloses a solution to the problem of making a stylish helmet through the use of a decorative cover for helmets. This idea presents two problems. The first problem is that, like helmets decorated by manufacturers, the helmet user is limited to choosing designs created for them by a manufacturer. Once again, the user is taken entirely out of the creative process of decorating their helmet. The second problem with Meeds' helmet covers is that they can create a safety hazard. His helmet coverings project from the surface of the helmet, and can be made of non-smooth materials. Attaching any such device to the outside of a helmet poses the risk of having the device snag on an object as the helmet user moves past it at high speed. Such an occurrence can cause the helmet user's head to be pulled in a direction other than their original course of motion, and can cause injury to the user's neck.

Though some have tried to provide a helmet which could satisfy the demands of the user for stylish decoration, all helmets heretofore known suffer from the above discussed disadvantages:

(a) The decoration is chosen by a manufacturer, giving the user no input in the creative process of decorating their helmet.

(b) The decoration is permanent and unalterable, leaving the user no recourse should their preferred style of decoration change.

(c) Many art products used to decorate helmets contain chemicals which degrade and damage the helmet.

(d) The artistic medium used to decorate the helmet is easily erased and not waterproof, and thus the user's decorations can be expected to be destroyed when the helmet is used, and a mess can be expected to be caused.

(e) Alternatively, the artistic medium employed by the user to decorate the helmet is permanent, and thus mistakes are unalterable and decorations unchangeable.

(f) Coverings of the helmet give the user no input in the decorating process, and pose a safety hazard.

### SUMMARY

In accordance with one embodiment a helmet, a plurality of markers, a solvent based cleaning solution, and a means for applying the cleaning solution to the helmet, which together allow the user to decorate their own helmet, with decorations that can survive a helmet's normal usage in sporting activities, and with the ability to change their decorations when they choose to do so.

### Advantages

Accordingly, several advantages of one or more aspects are as follows: to provide a sporting helmet, along with a plurality of markers filled with ink, a solvent based cleaning solution, and a means for applying the solvent based cleaning solution to the surface of the helmet, which together can be used to decorate the helmet, which decoration, when dry, will become waterproof and unable to be wiped off without the use of chemicals or without scratching the surface of the helmet, which decoration can be removed with the use of the solvent based cleaning solution and means of applying the solution to the surface of the helmet, which solvent based cleaning solution does not damage the helmet over the course of the helmet's useful life, and which together allows the user to decorate their helmet without fear of their decorations being inadvertently erased during normal use of the helmet, and which allows them to redecorate the helmet whenever they choose to do so. Other advantages of one or more aspects will be apparent from a consideration of the drawings and ensuing description.

### DRAWINGS

### Figures

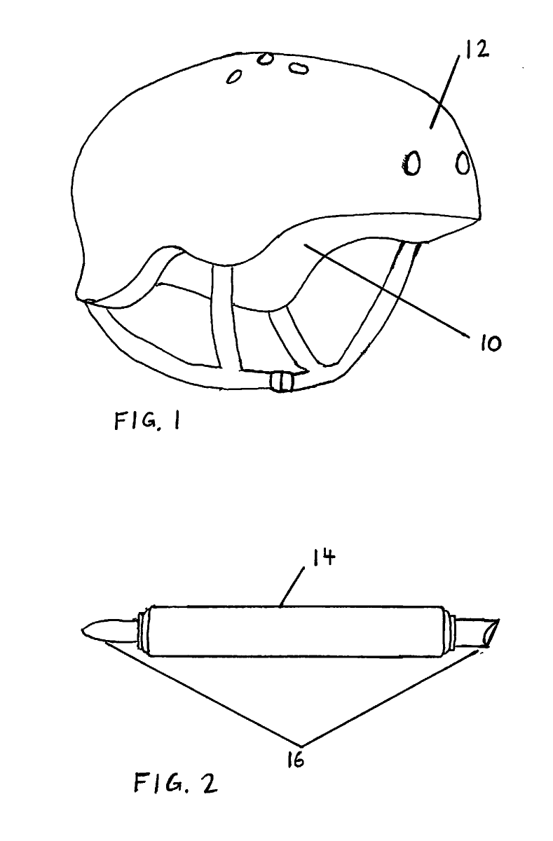

FIG. 1 shows a sporting helmet.

FIG. 2 shows a marker with two tips.

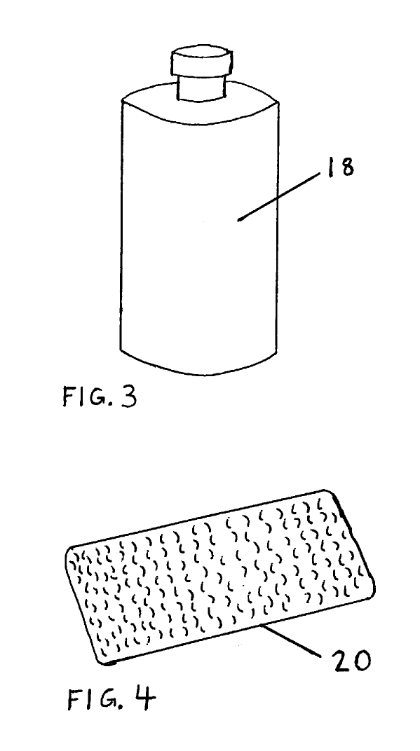

FIG. 3 shows a bottle of solvent based cleaning solution.

FIG. 4 shows a plastic scouring pad.

DRAWINGS—REFERENCE NUMERALS

| | | | |
|---|---|---|---|
| 10 | helmet | 12 | plastic outer shell |
| 14 | marker | 16 | marker tip |

| | |
|---|---|
| 18 | solvent based cleaning solution in a bottle |
| 20 | plastic scouring pad |

### DETAILED DESCRIPTION

### FIGS. 1, 2, 3, and 4

One embodiment of the helmet is illustrated in FIGS. 1, 2, 3, and 4. The helmet 10 has a plastic outer shell 12, the surface of which is able to be decorated with markers 14. The plastic outer shell 12 in one embodiment is made of ABS plastic. However, the plastic outer shell 12 can be constructed out of any similar material that is rigid enough to provide protection to a helmet 10 wearer's head in a crash.

A plurality of markers 14 are provided with the helmet 10. These markers 14 are filed with an ink which is used to decorate the plastic outer shell 12 of the helmet 10. In one embodiment, the markers 14 have two marker tips 16. One marker tip 16 is chisel shaped, while the other marker tip 16 is pointed, to provide the user with wider artistic possibilities in decorating the helmet 10.

In one embodiment, the ink used in the markers 14 is alcohol-based ink. At present, I believe this embodiment operates most efficiently, as alcohol-based ink forms a tight enough bond with the ABS plastic outer shell 12 of one embodiment that the ink, when dry, becomes waterproof and unable to be wiped off the plastic outer shell 12 without the use of chemicals or without scratching or otherwise damaging the plastic outer shell 12. However, the chemical bond formed between alcohol-based ink and the plastic outer shell 12 is still weak enough that it can be broken with mild solvents that will not damage the helmet 10 over the course of the helmet's 10 useful lifetime. The alcohol-based ink of this embodiment also has the advantage of drying quickly, which reduces the likelihood of the ink being inadvertently smudged as the user decorates their helmet 10. Other embodiments are also satisfactory, but alcohol-based ink provides the ability for the user's decorations to stand up to the expected rigors of sporting activity without being erased, while at the same time providing the ability to be removed, through use of the solvent based cleaning solution 18, whenever the user so chooses.

A solvent based cleaning solution 18 is provided with the helmet 10. In one embodiment, the solvent based cleaning solution 18 is stored in a bottle or similar container, with a cap, nozzle, sprayer, or other device to deliver the solvent based cleaning solution 18 when needed. In one embodiment, the solvent based cleaning solution 18 is comprised of isopropyl alcohol, which isopropyl alcohol constitutes 60% of the overall solution, as well as a mild liquid soap, and water. At present, I believe this embodiment operates most efficiently, but other embodiments are also satisfactory. This embodiment of the solvent based cleaning solution has the advantage of having a solvent which is compatible with the alcohol-based ink used in one embodiment, so that decorations on the helmet 10 can be removed quickly and with little rubbing. This embodiment is also advantageous because the low concentration of solvent allows for the solvent based cleaning solution 18 to be used on the helmet 10 repeatedly over the course of the helmet's 10 useful life without damaging the helmet 10 to the point of rendering it unsafe for use. Additionally, this embodiment is also advantageous because the liquid soap operates as both a lubricant and a surfactant, allowing for quick and easy removal of decorations from the plastic outer shell 12 of the helmet 10. Finally, this embodiment is advantageous due to the low toxicity of the ingredients used, rendering it safe for use by children with minimal adult supervision. Other embodiments of the solvent based cleaning solution are possible and can perform satisfactorily, such as those using different solvents, different concentrations of solvents, or with different soaps, or with no soaps at all.

A means for applying the solvent based cleaning solution is provided with the helmet 10. In one embodiment, this means for applying the solvent based cleaning solution is a plastic scouring pad 20. The plastic scouring pad 20 is soft enough that its repeated use will not scratch or otherwise damage the plastic outer shell 12 of the helmet 10. In other embodiments, the means for applying the solvent based cleaning solution 18 can be steel wool, other abrasive pads, or the user's hand.

### Operation—FIGS. 1, 2, 3, and 4

The manner of using one embodiment is as follows. One uses the markers 14 to draw one's desired decorations upon the plastic outer shell 12 of the helmet 10. Once the ink dries, the decorations become waterproof and are unable to be wiped away without use of chemicals or without scratching or damaging the plastic outer shell 12 of the helmet 10. At this point, the helmet is ready for use in sporting activities.

If one makes a mistake when decorating one's helmet 10, or if one desires for any reason to change the decorations on one's helmet 10, the solvent based cleaning solution 18 and a means for a applying the solvent based cleaning solution are employed. One puts a small amount of the solvent based cleaning solution 18 onto the means for applying the solvent based cleaning solution, and then rubs the means onto the plastic outer shell 12 of the helmet 10. When rubbed onto the plastic outer shell 12, the solvent based cleaning solution 18 will remove any ink it touches. In this way, one can remove only precise areas of decorations in order to fix mistakes, or can erase the decorations off of large areas of the plastic outer shell 12, or the entirety of the plastic outer shell 12. Thus, one can remove previously applied decorations, and can repeat the above described manner of use of one embodiment, so that the helmet 10 can be decorated repeatedly, whenever one so chooses.

### ADVANTAGES

From the description above, a number of advantages of some embodiments of my self-designable sporting helmet become evident:

(a) The user is able to decorate their own sporting helmet.

(b) The ink dries quickly on the plastic outer shell of the helmet, and thereafter cannot be smudged.

(c) Once dry, the ink becomes waterproof and able to stand up to the expected rigors of sporting use without being erased or distorted, so that the user's decorations can last as long as the user chooses.

(d) The solvent based cleaning solution provides the user with the ability to erase mistakes in their decorations, or to erase their prior decorations entirely, allowing for as many opportunities to redecorate the helmet as the user chooses.

(e) The markers, ink, solvent based cleaning solution, and means for applying the solvent based cleaning solution are compatible for use with the helmet, and are safe to use without the threat of physically or chemically damaging the helmet to the point of rendering the helmet unsafe.

(f) The chemicals used are of low toxicity, and are safe for use by children with minimal adult supervision.

### CONCLUSION, RAMIFICATIONS, AND SCOPE

Accordingly, the reader will see that the helmet, markers, solvent based cleaning solution, and means for application of the solvent based cleaning solution of the embodiment allow a user to decorate their own sporting helmet. Furthermore, the ink used to decorate the helmet dries quickly, and becomes waterproof and unable to be removed without the use of chemicals or without damaging the helmet's surface. Thereby, the user can have a helmet decorated with their own ideas and by their own hand, which will survive the wear and tear expected in sporting endeavors. They will also have the ability, through use of the solvent based cleaning solution, to fix mistakes in their decorations, or erase their previous decorations entirely, whenever they so choose, in order to prepare the helmet to be decorated again and again.

The embodiment provides all of the above advantages, while at the same time remaining safe, as the integrity of the helmet is not compromised through use. Also, due to their low toxicity, the use of the different aspects of the embodiment is safe.

Although the description above contains many specifics, these should not be construed as limiting the scope of the embodiments but as merely providing illustrations of some of several embodiments. For example, the solvent based cleaning solution could use other solvents as its base other than isopropyl alcohol, the markers could have only one tip, or tips of various shapes, and the means for applying solvent based cleaning solution to the helmet could be made of many different abrasive pads. Thus, the scope of the embodiments should be determined by the appended claims and their legal equivalents, rather than by the examples given.

I claim:

1. A sporting helmet, comprising:
a. a helmet with a plastic outer shell capable of being drawn upon
b. a plurality of markers which can be used to draw upon said plastic outer shell of said helmet
c. an ink, which will be loaded into said markers and drawn onto said plastic outer shell, which, when dry, becomes waterproof and unable to be wiped off of said plastic outer shell without the use of chemicals or without scratching or damaging said plastic outer shell
d. a solvent based cleaning solution for removing said ink from said plastic outer shell after said ink has dried, which said solvent based cleaning solution will not damage and render unsafe said helmet over the useful lifetime of said helmet, and
e. means for applying said solvent based cleaning solution to said plastic outer shell without scratching or damaging said plastic outer shell.

2. The helmet of claim 1 wherein said plastic outer shell is constructed of ABS plastic.

3. The helmet of claim 1 wherein said helmet has an EPS foam inner liner below said plastic outer shell.

4. The markers of claim 1 wherein said markers have two tips, one chisel shaped, and the other pointed, whereby the user can chose whichever tip is more helpful in drawing their intended designs.

5. The ink of claim 1 wherein said ink is alcohol based.

6. The solvent based cleaning solution of claim 1 wherein said solvent based cleaning solution uses isopropyl alcohol as its solvent.

7. The means for applying said solvent of claim 1 wherein said means is a plastic scouring pad.

8. The means for applying said solvent of claim 1 wherein said means is steel wool.

9. A method of decorating a sporting helmet, comprising:
providing a helmet with a plastic outer shell, a plurality of markers filed with an ink, a solvent based cleaning solution, and a means for applying said solvent based cleaning solution to said plastic outer shell, and
decorating said plastic outer shell with said ink by means of said markers, and
allowing said ink to dry and become waterproof and unable to be wiped off of said plastic outer shell without the use of chemicals or without scratching or damaging said plastic outer shell, and
applying said solvent based cleaning solution to said plastic outer shell with said means of applying said solvent based cleaning, whereby said ink is removed from said plastic outer shell without damaging and rendering unsafe said helmet over the useful lifetime of said helmet.

10. The method of claim 9 wherein said plastic outer shell is constructed of ABS plastic.

11. The method of claim 9 wherein said helmet has an EPS foam inner liner below said plastic outer shell.

12. The method of claim 9 wherein said markers have two tips, one chisel shaped, and the other pointed, whereby the user can chose whichever tip is more helpful in drawing their intended designs.

13. The method of claim 9 wherein said ink is alcohol based.

14. The method of claim 9 wherein said solvent based cleaning solution uses isopropyl alcohol as its solvent.

15. The method of claim 9 wherein said means is a plastic scouring pad.

16. The method of claim 9 wherein said means is steel wool.
